(19) United States
(12) Patent Application Publication
(10) Pub. No.: US 2025/0149256 A1
(43) Pub. Date: May 8, 2025

(54) METAL FOIL FOR PRODUCING ELECTRODE FOIL, METHOD FOR PRODUCING ELECTRODE FOIL FOR ELECTROLYTIC CAPACITOR USE, ELECTRODE FOIL FOR ELECTROLYTIC CAPACITOR USE, AND ELECTROLYTIC CAPACITOR

(71) Applicant: Panasonic Intellectual Property Management Co., Ltd., Osaka (JP)

(72) Inventors: Mitsuhisa YOSHIMURA, OSAKA FU (JP); Toshifumi KADOKAWA, HYOGO KEN (JP); Masami TSUBAKI, KYOTO FU (JP)

(21) Appl. No.: 19/018,830

(22) Filed: Jan. 13, 2025

Related U.S. Application Data
(63) Continuation of application No. PCT/JP2023/027538, filed on Jul. 27, 2023.

(30) Foreign Application Priority Data
Jul. 29, 2022 (JP) 2022-122129

(51) Int. Cl. H01G 9/055; H01G 9/045

(52) U.S. Cl. CPC H01G 9/055; H01G 9/045

(57) ABSTRACT

A method for producing an electrode foil for electrolytic capacitor use includes: preparing a raw material foil; and etching the raw material foil. The raw material foil contains a valve metal, and has a plurality of recesses that open on a main surface thereof and that are arranged to be distributed in a dot-like manner in the direction of the main surface. The opening diameter of the recesses is 2 μm or more.

### CROSS REFERENCE TO RELATED APPLICATIONS

The present application is a continuation application of International Application No. PCT/JP2023/027538, filed on Jul. 27, 2023, which claims the priority benefit of Japanese Patent Application No. 2022-122129, filed on Jul. 29, 2022, the entire contents of each of which are hereby incorporated herein by reference.

### TECHNICAL FIELD

The present disclosure relates to a metal foil used for producing an electrode foil, a method for producing an electrode foil for electrolytic capacitor use, an electrode foil for electrolytic capacitor use, and an electrolytic capacitor.

### BACKGROUND

For electrode foils of electrolytic capacitors, a metal foil (etched foil) having a porous portion formed on a surface thereof by etching is used. As a result, the electrode foils have a large surface area to increase the capacity of the electrolytic capacitors.

Japanese Laid-Open Patent Publication No. 2017-224844 discloses “an electrode foil which is made of a strip-shaped foil, including: surface enlarged parts that are formed on a surface of the foil; a core portion which is a part remained when excluding the surface enlarged parts within the foil; and a plurality of separation parts that extend in a belt width direction in the surface enlarged parts, and divide the surface enlarged parts; wherein the separation parts have a groove width of 50 μm or less including 0 when the foil is flat.”

### SUMMARY

### Technical Problem

In Japanese Laid-Open Patent Publication No. 2017-224844, provision of the separation parts increases the indentation depth (Erichsen value) in the Erichsen test. However, the folding endurance in the width direction of the electrode foil is therefore low because the separation parts extend in the width direction of the electrode foil. Stress generated during electrode foil winding forms cracks in the width direction of the electrode foil along the separation parts to form clefts extending substantially linearly from one end to the other end of the electrode foil in the width direction. As a result, foil tearing is likely to occur. It is still insufficient to inhibit foil tearing during electrode foil winding.

### Solution to Problem

One aspect of the present disclosure relates to a metal foil used for producing an electrode foil for electrolytic capacitor use, including a valve metal, wherein the metal foil has a plurality of recesses that open on a main surface of the metal foil and that are arranged to be distributed in a dot-like manner in a direction of the main surface, and an opening diameter of the recesses is 2 μm or more.

Another aspect of the present disclosure relates to a method for producing an electrode foil for electrolytic capacitor use, including: preparing the aforementioned metal foil; and etching the metal foil.

Still another aspect of the present disclosure relates to an electrode foil for electrolytic capacitor use obtained by the aforementioned method for producing an electrode foil for electrolytic capacitor use.

Still another aspect of the present disclosure relates to an electrode foil for electrolytic capacitor use including a metal foil containing a valve metal, wherein the metal foil has a plurality of recesses that open on a main surface of the metal foil and that are arranged to be distributed in a dot-like manner in a direction of the main surface, the metal foil has a porous portion having pores that open on the main surface of the metal foil and inner wall surfaces of the recesses, an opening diameter of the recesses is 2 μm or more, and an opening diameter of the pores of the porous portion is less than 2 μm.

Yet another aspect of the present disclosure relates to an electrolytic capacitor comprising the aforementioned electrode foil for electrolytic capacitor use.

### Advantageous Effect of Invention

According to the present disclosure, foil tearing during of winding of an electrode foil for electrolytic capacitor use can be inhibited.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic front view of an example of the main part of an electrode foil for electrolytic capacitor use according to an embodiment of the present disclosure.

FIG. 2 is a schematic front view of another example of the main part of the electrode foil for electrolytic capacitor use according to an embodiment of the present disclosure.

FIG. 3 is a cross-sectional view taken along a line III-III in FIG. 2.

FIG. 4 is a diagram schematically illustrating an example of a wound body when viewed from a side of an end surface thereof.

FIG. 5 is a schematic cross-sectional view of an electrolytic capacitor according to an embodiment of the present disclosure.

FIG. 6 is a schematic perspective view of the configuration of the wound body.

FIG. 7 is a SEM image showing a post-winding state of an electrode foil for electrolytic capacitor use according to an embodiment of the present disclosure.

FIG. 8 is a SEM image showing the main part of an electrode foil for electrolytic capacitor use according to an embodiment of the present disclosure.

FIGS. 9A and 9B are SEM images each showing the main part of an electrode foil when a recess group is provided after the metal foil is etched. FIG. 9A shows the case where the depth of recesses is small, and FIG. 9B shows the case where the depth of the recesses is large.

FIGS. 10A to 10H illustrate specific examples of the opening shape of the recesses. FIG. 10A to 10C illustrate cases where the opening shapes of the recesses are circular, rectangular, and hexagonal, respectively. FIG. 10D illustrates the case where the opening shape of the recesses is a rectangular shape with all the corners rounded. FIG. 10E to FIG. 10G each illustrate the case where the opening shape of the recesses is a drop shape. FIG. 10H illustrates the case where the opening shape of the recesses is hexagram.

### DETAILED DESCRIPTION

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be replaced with “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one kind of them may be selected and used singly, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

A method for producing an electrode foil for electrolytic capacitor use according to an embodiment of the present disclosure includes a first step and a second step.

In the first step, a metal foil used for producing an electrode foil according to an embodiment of the present disclosure is prepared as a metal foil (also referred to below as “raw material foil”) used for producing an electrode foil for electrolytic capacitor use.

The metal foil used for producing an electrode foil according to the embodiment of the present disclosure contains a valve metal and has a plurality of recesses that open on a main surface thereof. The recesses are arranged to be distributed in a dot-like manner in the direction of the main surface of the metal foil (when the metal foil is viewed in the normal direction of the main surface). That is, the recesses are spaced apart from each other. Each of the recesses has an opening diameter (also refer to below as “opening diameter D”) of 2 μm or more. The dot-like distribution of the recesses may be uniform, non-uniform, regular, or non-regular.

The opening diameter of the recesses means the maximum diameter of the opening of each individual recess. Hereinafter, a plurality of recesses having an opening diameter of 2 μm or more may be collectively referred to as a “recess group”. Here, the recesses of the recess group are open on a main surface of the metal foil and arranged to be distributed in a dot-like manner in the direction of the main surface. The recess group may be provided on one of the main surfaces of the metal foil or may be provided on each of the main surfaces of the metal foil.

In the second step, the metal foil is etched to form a porous portion on the surface of the metal foil. The aforementioned production method may further include a third step of forming a dielectric layer on the surface of the etched metal foil, for example, by chemical conversion treatment.

The electrode foil for electrolytic capacitor use according to an embodiment of the present disclosure is obtained by the above-described production method. That is, the electrode foil is obtained by etching the above-described metal foil (and additionally performing chemical conversion treatment or the like, if necessary). Hereinafter, the metal foil having the porous portion formed by etching is also referred to as an “etched foil.” The metal foil subjected to chemical conversion treatment after etching is also referred to as a “chemically converted foil”.

The etched foil obtained by the above-described production method includes a metal foil containing a valve metal. The metal foil has a plurality of recesses that open on a main surface of the metal foil and that are arranged to be distributed in a dot-like manner in the direction of the main surface. The etched foil has a porous portion having pores that open on the main surface of the metal foil and the inner wall surfaces of the recesses. The opening diameter of the recesses is 2 μm or more, and the opening diameter of the pores of the porous portion is less than 2 μm. The opening diameter of the pores of the porous portion means the maximum diameter of the opening of each individual pore. The opening diameter of the recesses is larger than the opening diameter of the pores of the porous portion. The chemically converted foil further includes a dielectric layer covering a metal skeleton constituting the porous portion.

The metal foil having the recess group has increased folding endurance. As a result of the recess group being present, good-quality cracks can be formed between the recesses during metal foil winding to relax a stress generated by winding, thereby inhibiting foil tearing. Formation of good-quality cracks by providing the recessed group inhibits formation of large clefts which can cause foil tearing. Here, formation of the large clefts linearly extend from one end to the other end of the foil in the width direction can be prevented. Due to foil tearing tending to occur especially during winding of an etched foil or a chemically converted foil, effect of inhibiting foil tearing achieved through formation of the recess group is remarkably exhibited. In a chemically converted foil having a high conversion voltage, effect of stress relaxation by formation of the recess group is also remarkably exhibited. Note that the metal foil winding is performed, for example, by winding a metal foil (a raw material foil, an etched foil, or a chemically converted foil) using a roller, slitting an electrode foil, or forming a wound body including an electrode foil.

Formed good-quality cracks extend from the inner walls of the recesses when viewed from a side of the main surface of the metal foil so that the cracks extending from the recesses are connected to each other. The length and shape of the cracks, the direction in which the cracks extend, and the like can be controlled in the presence of the recess group. Depending on the location of the recess group, the formed cracks can be slightly curved between the recesses on the main surface of the metal foil.

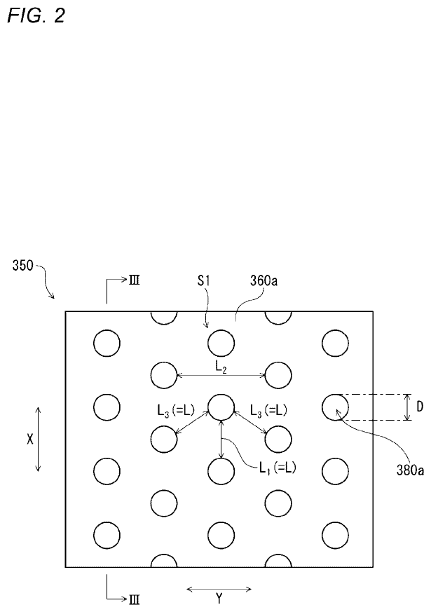

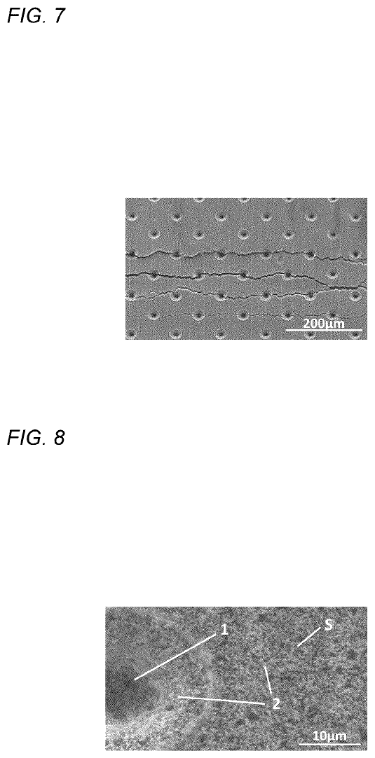

Here, FIG. 7 is a SEM image showing a post-winding state of an electrode foil for electrolytic capacitor use according to an embodiment of the present disclosure, and a part of the surface of the electrode foil is shown. The longitudinal direction in the SEM image of FIG. 7 is the length direction (winding direction) of the strip-shaped electrode foil, and is also the rolling direction of the electrode foil. The recess group in FIG. 7 is provided in a staggered manner. FIG. 7 shows the case where L₁ is larger than L₃, L₁ is substantially the same as L₂ in dimension, and L₃ is an interval L in the recess group illustrated in FIG. 2. As shown in FIG. 7, by winding the electrode foil, good-quality cracks can be formed between the recesses in a direction perpendicular to the winding direction (rolling direction).

During an electrolytic capacitor production process, a metal foil (sheet) may come into contact with a treatment liquid (e.g., an etchant or a conversion solution) and a roller, which can form protrusions and indentations (or scratches). Stress may concentrate on the protrusions and indentations during electrode foil winding, causing foil tearing during electrode foil winding. In addition, a rolled foil (Al raw material foil) is usually used as the raw material foil, and has rolling marks formed during the production process thereof. Due to the presence of the rolling marks, etched pits are formed non-uniformly and the folding endurance is locally reduced, so that foil tearing may be caused during electrode foil winding. By contrast, the above-described foil tearing can be inhibited in the electrode foil having the recess group.

In addition, foil tearing may be caused due to vibration when an electrolytic capacitor including a wound body is used. By contrast, foil tearing due to vibration when the electrolytic capacitor is used can be inhibited in the electrode foil having the recess group, and the electrode foil is preferably used in electrolytic capacitors such as those used in automotive applications where high reliability against vibration is required.

Further, in the above production method, the metal foil (raw material foil) having the recess group is etched. In this case, the porous portion is formed that has pores (etched pits) that open on the main surface of the metal foil and the inner wall surfaces of the recesses. This can increase the surface area of the metal foil to achieve a high capacity.

When the recess group is provided in the etched foil after the metal foil is etched, the pores (etched pits) located in the vicinity of the inner wall surfaces of the recesses tend to be clogged in formation of the recess group, and the pores that open on the inner wall surfaces of the recesses are less likely to be formed. This reduces the surface area of the metal foil by that amount. When the recesses are formed by pressing a jig having protrusions against the metal foil, the porous portion are deformed by pressing to clog the etched pits. When the recesses are formed by laser irradiation, laser-irradiated parts are melted to clog the etched pits. In formation of recesses having a large depth (e.g., recesses having a depth H of 5 μm or more), energy (or pressure in pressing) of irradiation in processing is large, so that the etched pits are easily clogged by melting (deformation). When the influence of etched pit clogging caused by melting (deformation) is significant, the capacity may decrease and the strength may also decrease. The aforementioned clogging includes not only clogging in the case where etched pits are completely clogged but also clogging in the case the case where a parts of etched pits are clogged.

By contrast, in the production method according to the present embodiment, etching in the second step is performed after the formation of the recess group. This makes it possible to avoid decreases in capacity and strength caused by melting (deformation) of the porous portion during formation of the recess group. In the case where recesses having a depth H of 20 μm or more are formed, effects of increasing strength and capacity in the production method according to the present embodiment can be remarkably exhibited.

Here, FIG. 8 is a SEM image showing the main part of an electrode foil produced by the above-described production method. As shown in FIG. 8, the electrode foil has mortar-shaped recesses 1 that open on a main surface S. The electrode foil is an etched foil, and the porous portion 2 is formed on the main surface S and the inner wall surfaces of the recesses 1. The porous portion 2 has pores that open on the inner wall surfaces of the recesses 1 in addition to pores that open on the main surface S.

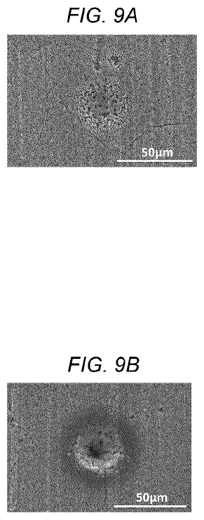

Here, FIGS. 9A and 9B are SEM images each showing the main part of an electrode foil including the recess group provided after a metal foil is etched. FIG. 9A shows the case where the depth of the recesses is as small as 5 μm, and FIG. 9B shows the case where the depth of the recesses is as large as 45 μm. The recesses in each case are formed by laser processing. Etched pit clogging is observed that is caused by melting of the inner wall surfaces of the recesses accompanying laser irradiation. The electrode foil of FIG. 9B, in which the depth of the recesses is larger, is more susceptible to laser processing and has a larger degree of etched pit clogging.

### First Step

### (Metal Foil Having Recess Group)

The metal foil prepared in the first step (the metal foil used in a later-described recess group formation step) does not include a porous portion formed by etching, a dielectric layer formed by chemical conversion treatment or the like, and a later-described coating layer formed in the case of a cathode foil.

The metal foil prepared in the first step contains a valved metal. The valve metal includes aluminum (Al), tantalum (Ta), niobium (Nb), titanium (Ti), or zirconium (Zr), for example. The metal foil may contain the valve metal in the form of an alloy or compound containing the valve metal.

When the metal foil contains aluminum (Al) as the valve metal, the Al content rate in the metal foil may be 98 mass % or more, and may be 99 mass % or more (or 99.5 mass % or more). In view of increasing electrode foil capacity, the metal foil is preferably a soft foil (Al content rate: 98 mass % or more). Above all, in view of increasing the capacity, the Al content rate in the metal foil is preferably 99.8 mass % or more.

The metal foil may contain a trace amount of an additional element other than the valve metal. Examples of the additional element include silicon (Si), copper (Cu), and iron (Fe). The Si content in the metal foil is preferably 1 mass ppm or more and 100 mass ppm or less, for example, and more preferably 5 mass ppm or more and 80 mass ppm or less. The Cu content in the metal foil is preferably 5 mass ppm or more and 100 mass ppm or less, for example, and more preferably 5 mass ppm or more and 80 mass ppm or less. The Fe content in the metal foil is preferably 5 mass ppm or more and 200 mass ppm or less, for example, and more preferably 5 mass ppm or more and 100 mass ppm or less. In the metal foil, the total content rate of Si, Cu, and Fe is preferably 0.1 mass % or less, and more preferably 0.05 mass % or less.

The tensile strength of the metal foil having the recess group is preferably 25 N/mm² or more, more preferably 40 N/mm² or more, and further preferably 60 N/mm² or more. The tensile strength may be 120 N/mm² or less, for example. The elongation rate of the metal foil having the recess group is preferably 1% or more and 16% or less, and more preferably 2% or more and 14% or less.

When the tensile strength is 25 N/mm² or more (or 40 N/mm² or more) and/or the elongation rate is 1% or more (or 2% or more) in the metal foil having the recess group, foil tearing in the subsequent step is inhibited. A decrease in strength of the foil due to elongation of the foil in the later step is suppressed. Each strength of the etched foil and the chemically converted foil is sufficiently ensured. Examples of the later step include etching of the metal foil (and additional chemical conversion treatment as necessary), transport and winding of the metal foil using a roller, slit formation in the electrode foil, and configuration of a wound body including the electrode foil.

Typically, a rolled foil is usually used as the metal foil. The tensile strength and the elongation rate means tensile strength and elongation rate in the rolling direction, respectively. Usually, the rolling direction of a strip-shaped metal foil substantially matches the length direction of the metal foil. The tensile strength and elongation rate of the metal foil are determined, for example, in accordance with JIS Z 2241 (Metallic materials—Tensile testing—Method of test at room temperature).

In the depth direction of the recess, the number N of crystal grains of the metal foil exposed on the inner wall surface of each recess is preferably 2 or more (or 3 or more), and may be 2 or more (or 3 or more) and 10 or less. In this case, the strength (tensile strength, folding endurance) of the metal foil (etched foil, chemically converted foil) is easily ensured. The number N is desirably within the above range for 40% or more (or 60% or more) of the recesses constituting the recess group.

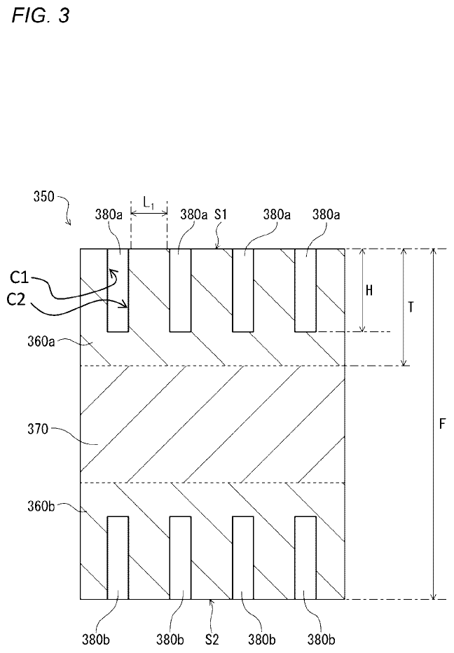

The number N of the crystal grains can also be said to be the number of crystal grains exposed on the side wall surface of each recess (the inner wall surface from the deepest part to the opening of the recess). The number N of the crystal grains is determined by the following method. Across-sectional SEM image of the metal foil in the thickness direction is captured using a scanning electron microscopy (SEM). As a result, with respect to each recess, two profiles of the side wall surfaces of the recess are observed. The respective two profiles are designated by C1 and C2 (e.g., C1 and C2 in FIG. 3 correspond to the two profiles of the side wall surfaces of each recess in the raw material foil). The number N1 of grain boundaries extending from the profile C1 of one sidewall surface to the interior of the metal foil is counted. The number N2 of grain boundaries extending from the profile C2 of the remaining sidewall surface to the interior of the metal foil is counted. An average of (N1+1) and (N2+1) is calculated as the number N of the crystal grains described above.

The average crystal grain diameter of the metal foil is preferably 18 μm or more (or 20 μm or more) and 60 μm or less. In this case, the metal foil (electrode foil) can have an appropriate hardness to achieve sufficient strength. Damage to the metal foil (electrode foil) is reduced, for example, during metal foil slitting or winding and connection between the electrode foil and the lead member. When the average crystal grain diameter is 18 μm or more, an appropriate number of grain boundaries are present. This suppresses a decrease in capacity caused by nonuniform distribution of the pits between in the vicinity of the grain boundaries and in other locations within the porous portion when many grain boundaries are present.

The average crystal grain diameter is obtained in a manner that: any area with a length F in the thickness direction and a length 2×F in the surface direction is selected in a cross-sectional SEM image of a metal foil (electrode foil) with a thickness of F; each maximum diameter of a plurality of crystals included in the area is measured; and an average of the maximum diameters is calculated.

The thickness F of the metal foil (electrode foil) may be 50 μm or more and 200 m or less, and may be 80 μm or more (or 100 μm or more) and 200 μm or less. When the thickness F of the metal foil is 80 μm or more (or 100 μm or more), stress generated during winding is large. Therefore, effect of stress relaxation by crack formation between the recesses is remarkably exhibited. The thickness F of the metal foil is obtained by averaging values of the thickness at any ten points on the metal foil, as measured in a cross-sectional SEM image of the metal foil in the thickness direction.

### (Recess Group)

In view of increasing the folding endurance and ensuring the tensile strength of the metal foil, the opening diameter of the recesses is preferably 5 μm or more and 100 μm or less, and more preferably 5 μm or more and 70 μm or less. From the point of view of further increasing the folding endurance of the metal foil, the opening diameter D of the recesses is further preferably 5 μm or more and 50 μm or less, and particularly preferably 5 μm or more and 40 μm or less. Further, from the point of view of easy formation of the pores (pits) that open on the inner wall surfaces of the recesses even in the deep part of the recesses, the opening diameter D of the recesses is preferably 8 μm or more, and more preferably 18 μm or more. In order to enhance the effect of increasing the folding endurance, it is desirable that the opening diameter of the recesses is small and the number of the recesses is large.

A ratio D/F of the opening diameter D (μm) of the recesses to the thickness F (μm) of the metal foil is preferably less than 0.5, and more preferably less than 0.25 (or less than 0.2).

The depth H of the recesses is preferably 4 μm or more and 74 μm or less, for example. The depth H of the recesses may be 5 μm or more (or 20 μm or more). The “depth H of the recesses” means a distance from the opening to the deepest part of the recesses.

A ratio H/F of the depth H (μm) of the recess to the thickness F (μm) of the metal foil is preferably 0.05 or more and 0.55 or less, more preferably 0.26 or more and 0.47 or less, and further preferably 0.3 or more and 0.43 or less. When the ratio H/F is within the above range, the folding endurance of the electrode foil is easily ensured, and the strength of the electrode foil (core) is easily ensured.

In of view of ensuring the tensile strength of the electrode foil and inhibiting foil tearing due to winding or the like of the electrode foil, the number of recesses present per area of 1 mm² of the main surface of the metal foil may be 7 or more and 570 or less, may be 7 or more and 120 or less, or may be 7 or more (or 15 or more) and 80 or less.

Mutually adjacent recesses are spaced apart by an interval L. The “mutually adjacent recesses” herein means recesses that are located next to each other and closest to each other. The “interval L” refers to the length of a line segment drawn to connect the mutually adjacent recesses at their shortest on the main surface of the metal foil. The interval L may be 4 μm or more, 9 μm or more, or 15 μm or more. The interval L may be 2000 μm or less, 1000 μm or less, 320 μm or less, or 250 μm or less. The interval L may be 9 μm or more and 320 μm or less, for example. When the opening diameter of the recess is 5 μm or more and 50 μm or less, the interval L is preferably 4 μm or more and 320 μm or less, and more preferably 9 μm or more and 250 μm or less.

Given that the respective opening diameters of the mutually adjacent recesses are D₁ (μm) and D₂ (μm), D₁ and D₂ may be the same as or different from each other. Here, “the same” means that D₁/D₂ is in the range of 6/10 or more and 10/6 or less. D₁/D₂ may be 8/10 or more and 10/8 or less, or may be 1. Hereinafter, the “opening diameter D₁” and the “opening diameter D₂” may be collectively referred to as “opening diameter D”.

The opening diameter D₁ (μm) and the interval L (μm) preferably satisfy the relationships of 2≤D₁ and 2≤L/D₁≤50. The opening diameter D₂ (μm) and the interval L (μm) preferably satisfy the relationships of 2≤D₂ and 2≤L/D₂≤50.

When L/D is 2 or more, the strength of the metal foil is easily ensured. Inf view of ensuring the strength, L/D may be 5 or more. When L/D is 50 or less, it is easy to obtain the benefits of the recesses. L/D may be 10 or less.

D₁, D₂, and L as above are determined as follows. An image of the main surface of a metal foil (electrode foil) is captured using a scanning electron microscopy (SEM). In the image, an opening having a maximum diameter of 2 μm or more is regarded as an opening of a recess, and two recesses positioned next to each other and closest to each other are regarded as mutually adjacent recesses. For the respective two recesses, the largest diameters of the respective openings are determined to be D₁ and D₂. Line segments each connecting the mutually adjacent recesses are drawn, and the length of the shortest line segment of the line segments is determined to be L.

The mutually adjacent recesses may be spaced apart by an interval L in a direction perpendicular to the winding direction when the metal foil (electrode foil) is wound. The “direction perpendicular to the winding direction” as used herein means a direction in which the angle relative to the winding direction is in a range of 65° to 115°. In the direction perpendicular to the winding direction, not all the recesses may be aligned in a certain direction, and recesses aligned in different directions within the range of the angle may be present.

The plurality of recesses may be arranged in a staggered manner. In this case, the recesses may be spaced apart by an interval L₁ (μm) in the winding direction when the metal foil (electrode foil) is wound, spaced apart by an interval L₂ (μm) in the direction perpendicular to the winding direction, and spaced apart by an interval L₃ (μm) in an oblique direction relative to the winding direction. In this case, the smallest interval among the intervals L₁ to L₃ is the interval L.

It is possible that the mutually adjacent recesses each have a circular opening having equal size, and one of the mutually adjacent recesses may be located in the winding direction when the metal foil (electrode foil) is wound relative to the other recess. In this case, the interval L may be 15 μm or more and 250 μm or less. Note that the phrase “located in the winding direction” encompasses not only the case where the mutually adjacent recesses are located in the winding direction when the metal foil (electrode foil) is wound but also the case where one of the recesses is displaced from the winding direction to the other recess in a direction perpendicular to the winding direction, within a range of one recess or less from the winding direction. The expression “equal size” means that D₁/D₂ is in the range of 6/10 or more and 10/6 or less. D₁/D₂ may be 8/10 or more and 10/8 or less, or may be 1.

The diameter of the recess may be larger at its opening than at its deep part. For example, given that the opening diameter of the recess is D, the diameter of the point of the recess, which is aligned with the opening diameter D and extends by D in the depth direction from the opening, may be 0.8 D or less, and may be 0.05 D or more and 0.8 D or less.

In view of increasing the tensile strength and the folding endurance, the recesses may extend with an inclination relative to the main surface of the metal foil. From the point of view of ease of recess formation, the recesses may extend perpendicularly to the main surface of the metal foil. The phrase “perpendicular to the main surface of the metal foil” means that the recesses extend at an angle of 80° to 100° relative to the main surface of the metal foil.

When the opening of one recess has a maximum diameter D_{L} and a minimum diameter D_{S}, a ratio D_{S}/D_{L} of the minimum diameter D_{S} to the maximum diameter D_{L} is preferably 0.1 or more and 1 or less, for example, and more preferably 0.2 or more and 0.8 or less. In view of increasing the tensile strength in the length direction and the folding endurance in the width direction of the strip-shaped metal foil, the recesses may be provided such that the direction of the maximum diameter D_{L} of the opening of each recess is substantially parallel to the length direction of the strip-shaped metal foil. The maximum diameter D_{L} is defined to be the same as the opening diameter D. The phrase “substantially parallel to the length direction of the metal foil” means that the angle between the direction of the maximum diameter D_{L} and the length direction is within a range of −20° to 20°.

Preferably, the recesses are regularly arranged in the surface direction of the metal foil. The recesses are preferably arranged at equal intervals in the surface direction of the metal foil. In the surface direction of the metal foil, the recesses may be arranged in a staggered manner or may be arranged in a square lattice pattern.

Examples of the shape of the openings of the recesses include circular, elliptical, polygonal, star, and drop shapes. Preferably, at least some of the corners of the polygon are rounded. More preferably, all of the corners of the polygon are rounded. The shapes of the openings of the recesses formed in the porous portion may be the same type as or different types from each other. Examples of the polygonal shape include triangular, rectangular, and hexagonal shapes. The star shape includes a shape having an internal angle of 180 degrees or more, and examples of the typical star shapes include awn star shapes such as pentagram and hexagram shapes. The plurality of sides forming a polygonal shape or a star shape may have the same length as or different length from each other. The rectangular shape may not be square; it can be rectangular, rhombic, or an elongated thin shape.

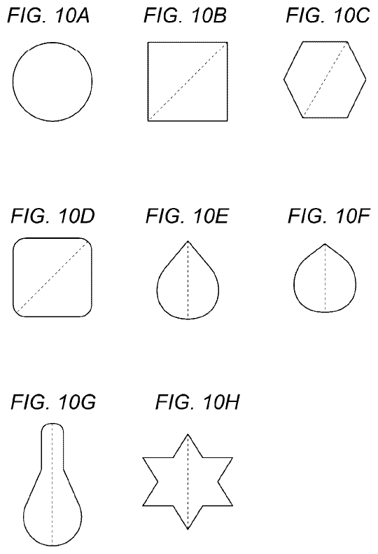

Specific examples of the shape of the openings of the recesses include circular, rectangular, and hexagonal shapes as illustrated in FIGS. 10A to 10C; a rectangular shape with all the corners rounded as illustrated in FIG. 10D; drop shapes as illustrated in FIGS. 10E to 10G; and a hexagram shape as illustrated in FIG. 10H. The broken lines in FIGS. 10B to 10H indicate the directions of respective maximum diameters DL. The recesses illustrated in FIGS. 10B to 10H may be provided such that the respective directions of the broken lines are substantially parallel to the length direction of the strip-shaped metal foil. The phrase “substantially parallel to the length direction of the metal foil” means that an angle between the direction of a broken line and the length direction is within a range of −20° to 20°.

Examples of the shape of the recesses include columnar shapes (e.g., a cylindrical shape, an oval prismatic shape, and angular prismatic shapes such as a rectangular prismatic shape), pyramidal shapes (e.g., a conical shape and angular pyramidal shapes such as a rectangular pyramidal shape), frustoconical shapes (e.g., a circular frustum shape and angular frustum shapes such as a rectangular frustum shape), hemispherical shapes, and mortar shapes. From the point of view of ease of processing, a conical shape, a triangular pyramidal shape, or a rectangular pyramidal shape is preferable.

It is possible that a first recess group is provided on one main surface of the metal foil, and a second recess group is provided on the other main surface of the metal foil. In this case, the first recess group and the second recess group may be the same as or may be different from each other, for example, in opening diameter D, interval L, shape, or arrangement of the recesses. When the metal foil is viewed in the normal direction of the main surface thereof, it is preferable that the recesses constituting the first recess group and the recesses constituting the second recess group are arranged with their positions displaced to avoid overlapping with each other.

The metal foil is a rolled foil, and the winding direction when the metal foil is wound may be parallel to the rolling direction of the rolled foil. In this case, the influence of rolling marks formed during winding can be reduced as compared with the case where the metal foil is wound in a direction perpendicular to the rolling direction. Note that the phrase “the winding direction is parallel to the rolling direction of the rolling foil” means that the angle between the winding direction and the rolling direction is in the range of −20° to 20°.

### (Recess Group Formation Step)

The first step may include a step of forming a recess group in a metal foil. As the metal foil used in the recess group formation step, a plane foil (e.g., an arithmetic mean roughness Ra of 3 μm or less) containing a valve metal is used. The arithmetic mean roughness Ra is obtained in accordance with JIS B 0601: 2001. In the recess group formation step, the recess group may be formed by pressing a jig having a plurality of protrusions against the metal foil. Alternatively, the recess group may be formed on each surface of the metal foil by pressing the metal foil using a pair of rollers each having a plurality of protrusions while the metal foil is transported between the pair of rollers. The recess group may be formed by laser processing, blasting, or etching, for example. The metal foil with the recess group formed by etching in the first step is not included in the above-described etched foil (the metal foil with the porous portion formed by etching).

### Second Step

In the second step, the raw material foil with the recess group formed thereon is etched to form a porous portion on the main surface of the raw material foil and the inner wall surface of the recess group. The etching in the second step is performed to form the porous portion. While the surface of the raw material foil is made porous by etching, formed recesses are sufficiently larger than the pores of the porous portion, and the recess group is maintained with the size and shape of the recesses in the raw material foil substantially unchanged even after etching.

Depending on the diameter size and shape of the recesses, an etched pit (porous portion) may be formed also on the bottom surface of each recess. In this case, formation of the porous portion proceeds toward the core portion in an area where the recesses are located, whereas the core portion is ensured to have a large thickness in an area where the recesses not located. Therefore, the capacitance can be increased while minimizing a decrease in strength.

Etching may be electrolytic etching or chemical etching. Electrolytic etching can mass-produce an electrode foil having a porous portion including pores with a diameter (opening diameter) of less than 2 μm. AC etching can produce an electrode foil having a porous portion including sponge-shaped pits with a diameter of 1.0 μm or less, and a high capacity foil can be produced by setting the diameter to 0.5 μm or less. DC etching can produce an electrode foil having a porous portion including tunnel-like pits with a diameter of less than 2 μm. In view of easily increasing the difference between the opening diameter of the pores of the porous portion and the opening diameter of the recess, AC etching is preferable.

### Third Step

The electrode foil production method may include a step of forming a dielectric layer covering a metal skeleton constituting the porous portion of the electrode foil. In the dielectric layer formation step, for example, an oxide film containing a valve metal may be formed on the surface of the porous portion by chemical conversion treatment (anodization). The conversion voltage in chemical conversion treatment of an Al foil may be, for example, 4 V or more, or 40 V or more. When the electrode foil is formed by AC etching, the conversion voltage is preferably 200 V or less.

### (Others)

The electrode foil production method may include a step of slitting the electrode foil. For example, a strip-shaped electrode foil having a width of 500 mm is slitted to have a width of 1.5 mm or more and 40 mm or less. The slitted electrode foil may be wound using a roller. By providing the recess group, foil tearing during winding by the roller can be inhibited even when the slit-width is small, measuring 10 mm or less.

### [Electrode Foil for Electrolytic Capacitor Use]

The electrode foil is obtained by etching a metal foil having a recess group. The etched metal foil has a porous portion and a core portion continuous with the porous portion. The porous portion is an outer portion of the metal foil made porous by etching, and the remaining portion which is an inner portion of the metal foil is the core portion. The porous portion is formed on a main surface of the metal foil and inner wall surfaces of a plurality of recesses. At least parts of the inner wall surfaces of recesses located near the opening thereof should be porous by etching in addition to the main surface of the metal foil. Preferably, almost the entire inner wall surfaces of the recesses are made porous. Parts of the inner wall surfaces of the recesses located deep inside may not be made porous, and the core portion may be exposed on parts of the inner wall surfaces of the recesses located deep within the recesses.

The porous portion has pores that open on the main surface of the metal foil and the inner wall surfaces of the recesses. The pores of the porous portion have an opening diameter of less than 2 μm. The opening diameter of the pores of the porous portion means the maximum diameter of the opening of each individual pore. The opening diameter of the recesses is larger than the opening diameter of the pores of the porous portion. When the opening diameter D of the recesses is 2 μm or more, good-quality cracks are formed during winding to inhibit foil tearing.

If the opening diameter D of the recesses is less than 2 μm, such good-quality cracks are hardly formed, tending to decrease folding endurance even when the opening diameter D of the recesses is larger than the opening diameter of the pores of the porous portion.

For example, a strip-shaped metal foil when used as the electrode foil, have a width dimension of 1.5 mm or more and 520 mm or less, for example.

A ratio H/T of the depth H (μm) of the recesses to a thickness T (thickness per one side) (μm) of the porous portion is preferably 0.1 or more and 1.35 or less, more preferably 0.2 or more and 1.1 or less, and further preferably 0.3 or more and 1 or less. When the ratio H/T is within the above range, the folding endurance of the electrode foil is easily ensured, and the strength of the electrode foil (core portion) is easily ensured. The ratio H/T may be larger than 1 and 1.35 or less (or 1.1 or less). That is, the recesses may further extend from the porous portion toward the core portion within a range in which the strength of the electrode foil (core portion) is ensured. In this case, the depth of the recess in the core portion is, for example, 10 μm or less, and may be 7 μm or less (or 5 μm or less). When the diameter of deep parts of the recesses is very small, the inner wall surfaces of the deep parts of the recesses may be hardly etched in some cases.

The thickness T of the porous portion means the thickness of the porous portion in a part of the metal foil having no recess. The thickness T of the porous portion is obtained by averaging the thickness values as measured at any ten points in the porous portion in a cross-sectional SEM image of the electrode foil in the thickness direction.

The porous portion may be formed on one of the main surfaces of the metal foil, or may be formed on each of the main surfaces of the metal foil. The porous portion is preferably formed on the inner wall surfaces of the plurality of recesses in addition to at least a main surface of the metal foil that includes the recess group.

The thickness T of the porous portion is not particularly limited, and can be appropriately selected, for example, according to application of the electrolytic capacitor or the required withstand voltage. The thickness T of the porous portion may be, for example, 1/10 or more and less than 5/10 (or 2/5 or less) of the thickness F of the metal foil per one side. In the case of an anode foil, the thickness T of the porous portion is 10 μm or more and 160 μm or less, for example, and may be 50 μm or more and 160 μm or less.

The metal foil has a metal skeleton constituting the porous portion. The metal skeleton refers to a metal portion having a microstructure in the porous portion. The porous portion has a plurality of pores (pits) surrounded by the metal skeleton. In view of increasing the surface area and forming the dielectric layer on a deep part of the porous portion, the pore diameter (opening diameter) is less than 2000 nm, and may be 100 nm or more and 1500 nm or less.

The shape of the pores (pits) may be a sponge-like or tunnel-like shape. The tunnel-like pits include pits extending from the surface of the porous portion toward the core portion. In the sponge-shaped pits, the pore diameter (opening diameter) is preferably 600 nm or less, for example, and more preferably 50 nm or more and 500 nm or less. The sponge-shaped pits have an average pore diameter Dp of preferably 80 nm or more and 400 nm or less, and more preferably 100 nm or more and 300 nm or less. An electrode foil having sponge-shaped pits is used in low-voltage electrolytic capacitors, for example. Specifically, it is used in electrolytic capacitors using a chemically converted foil having 200 V or less. In the tunnel-shaped pits, the pore diameter (opening diameter) is 1900 nm or less, for example, and may be 100 nm or more and 1800 nm or less. The tunnel-shaped pits have an average pore diameter Dp of preferably 200 nm or more and 1700 nm or less, more preferably 400 nm or more and 1400 nm or less. An electrode foil having tunnel-shaped pits is used in medium-to-high-voltage electrolytic capacitors using a chemically converted foil having of 180 V or more, for example.

The mean pore diameter Dp of the porous portion is determined by measuring a pore diameter distribution of the electrode foil (porous portion) using a mercury porosimeter. Specifically, a pore diameter (mode diameter) is obtained as the mean pore diameter Dp. Here, the pore diameter corresponds to the apex of a peak (largest peak when there are a plurality of peaks) appearing in the pore distribution curve (vertical axis: log differential pore volume, horizontal axis: pore diameter) obtained by measurement. As the measuring device, an AutoPore V series manufactured by Micromeritics Instrument Corporation is used, for example. The pore distribution curve indicates a distribution of the pores of the porous portion in a range in which the pore diameter is less than 2 μm. Usually, the diameter (opening diameter) of the recesses is much larger than that of the pores of the porous portion, and is difficult to measure by a mercury porosimeter under the same conditions as those for measurement of the porous portion.

### (Dielectric Layer)

The electrode foil may include a dielectric layer covering the metal skeleton constituting the porous portion. In this case, the electrode foil can be used as an anode foil. The dielectric layer covers the main surface of the metal foil, the inner wall surfaces of the recesses, and the inner wall surfaces of the pores of the porous portion.

The thickness of the dielectric layer may be 2 nm or more, 4 nm or more, 12 nm or more, or 24 nm or more. An electrode foil including a dielectric layer having a thickness of 24 nm or more can be used as an anode foil of electrolytic capacitors having a rated voltage of 20V or more. In particular, when used in a hybrid capacitor, it is preferable to form a dielectric layer having a thickness of 50 nm or more, and the conversion voltage during the chemical conversion treatment is preferably 30 V or more. When the conversion voltage is 30 V or higher, the dielectric layer becomes thick and problems in strength of the electrode foil are likely to occur. As such, effect of stress relaxation by clack formation between the recesses is significant. The thickness of the dielectric layer is determined by averaging the thickness values as measured at any ten points of the dielectric layer in a cross-sectional SEM image of the electrode foil in the thickness direction.

The electrode foil for electrolytic capacitor use according to the present embodiment may be used as at least one of an anode foil and a cathode foil for a winding-type electrolytic capacitor, or may be used as an anode body for a lamination-type electrolytic capacitor.

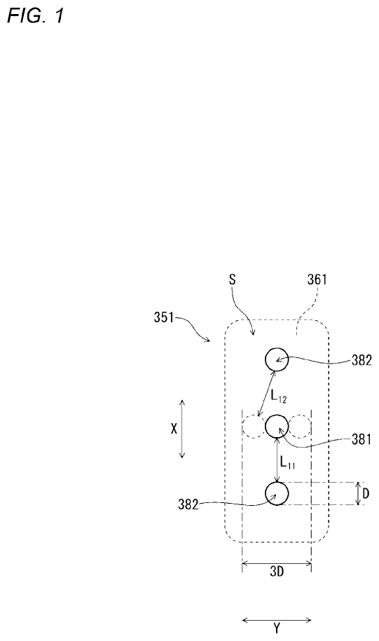

Here, FIG. 1 is a front view of an example of the main part of an electrode foil according to an embodiment of the present disclosure. In FIG. 1, the X direction and the Y direction indicate the length direction (winding direction) and the width direction of a strip-shaped electrode foil, respectively. While an electrode foil 351 has a recess group on a main surface S (in X direction and Y direction), FIG. 1 illustrates a partial region including recesses arranged in the X direction of the electrode foil 351.

As illustrated in FIG. 1, the main surface S of the electrode foil 351 has recesses 381 and 382 adjacent to each other, each of which has a circular opening with an opening diameter D of the same size. The opening diameter D is 2 μm or more. The electrode foil 351 has a porous portion 361 formed on the main surface S and the inner wall surfaces of the recesses 381 and 382. The porous portion 361 has pores (an opening diameter of less than 2 m) that open on the main surface S and the inner wall surfaces of the recesses 381 and 382.

The recesses 381 and 382 are spaced apart by an interval L₁₁ in the X-direction. One recess 381 may be slightly displaced from the other recess 382 in the Y direction (the direction perpendicular to the winding direction), within a range of one recess 381 or less (the opening diameter D or less) from the X direction. For example, one recess 381 may be formed apart by an interval L₁₂ in the X direction from another recess 382 so as to be slightly displaced in the Y direction (the direction perpendicular to the winding direction) within a range of one recess 381 or less (opening diameter D or less) to a position indicated by a dashed circle.

A ratio L₁₁/D (or L₁₂/D) may be 2 or more and 50 or less. L₁₁ (or L₁₂) may be 15 μm or more and 250 μm or less. When the metal foil is a rolled foil and the X direction corresponds to the rolling direction in the case in which L₁₁ (or L₁₂) is 15 μm or more, the strength in the rolling direction is ensured even if the recess group is provided in the rolling direction. In also this case, cracks are easily formed in the Y direction by winding, and cracks formed in the Y direction can be appropriately distributed in the X direction.

FIG. 2 is a schematic front view of another example of the electrode foil for electrolytic capacitor use according to an embodiment of the present disclosure. A strip-shaped electrode foil 350 (metal foil) of FIG. 2 has a first main surface S1 and a second main surface S2 opposite to the first main surface S1. FIG. 2 illustrates a part of the electrode foil 350 when viewed from a side of the first main surface S1. In FIG. 2, the X direction and the Y direction indicate the length direction and the width direction of the strip-shaped electrode foil, respectively. FIG. 3 is a cross-sectional view of FIG. 2 taken along a line III-III. FIG. 3 is a diagram schematically illustrating a cross section of the electrode foil 350 of FIG. 2 in the thickness direction and the Y direction. Note that the electrode foil for electrolytic capacitor use according to the present disclosure is not limited to the electrode foils illustrated in FIGS. 2 and 3. Each drawing is a schematic illustration, and the shape or features (e.g., opening diameter D of the recess and interval L) of each element of configuration in each drawing does not necessarily reflect the actual dimensions, and is not necessarily represented by the same scale ratio.

The strip-shaped electrode foil 350 (metal foil) has a plurality of columnar recesses 380a that open on the first main surface S1. The first recesses 380a are spaced apart from each other, and are arranged to be distributed in a dot-like manner in the surface direction (X direction and Y direction) of the electrode foil 350.

Across the main surface S1 of the electrode foil 350 and the inner wall surfaces of the recesses 380a, a first porous portion 360a is formed. The first porous portion 360a has pores (not illustrated) that open on the first main surface S1 and the inner wall surfaces of the first recesses 380a. The pores of the first porous portion 360a have an opening diameter of less than 2 μm. The electrode foil 350 has a core portion 370 that is continuous with the first porous portion 360a. When the electrode foil 350 is a rolled foil, the X direction desirably corresponds to the rolling direction.

As illustrated in FIG. 2, the first recesses 380a are arranged at equal intervals in a staggered manner. Mutually adjacent first recesses 380a are spaced apart from each other by an interval L. The first recesses 380a have a circular opening having an opening diameter D (μm). The opening diameter D of the first recesses 380a is 2 μm or more. In this case, good-quality cracks are formed between the first recesses 380a during electrode foil winding, in which the winding direction corresponds to the X direction, to relax a stresses generated by winding and increase the folding endurance in the Y direction, thereby inhibiting foil tearing during winding.

The first recesses 380a are arranged at intervals L₁ (μm) in the winding direction (X direction) when the metal foil is wound, arranged at intervals L₂ (μm) in a direction (Y direction) perpendicular to the winding direction, and arranged at intervals L₃ (μm) in an oblique direction relative to the winding direction (X direction). L₁ and L₃ are equal to each other, are smaller than L₂, and correspond to the interval L. L₁/D and L₃/D are 2 or more and 50 or less. The interval L₁ and the interval L₂ satisfy a relationship of 2<L₂/L₁. In this case, the folding endurance in the Y direction is significantly increased. In particular, when a large stress in the Y direction is generated, effect of stress relaxation by crack formation between the recesses is remarkably exhibited. Examples of such the case include during slitting of the electrode foil, during change in bending timing or traveling angle of the electrode foil in the course of transport of the electrode foil, during formation of a wound body, and during connection between the electrode foil and a lead member by crimping.

Although L₁ is approximately the same as L₃ in dimension in FIG. 2, the arrangement of the recesses may be adjusted so that L₁ is smaller than L₃, or the arrangement of the recesses may be adjusted so that L₁ is larger than L₃. Among them, the relationship of L₁>L₃ is desirable. In this case, L₁ may be approximately the same as L₂ in dimension and L₃ may correspond to the interval L.

Metal foil winding in the X direction easily forms cracks in the direction of L₂ (the Y direction) in FIG. 2. Depending on the size of the interval L₁, cracks can be formed mainly in the direction of L₂ (the Y direction) in FIG. 2, and also formed in the direction of L₃ in FIG. 2 at a certain degree. Thus, a stress generated by winding can be effectively relaxed. In view of the above, L₁ may be 15 μm or more and 250 μm or less, for example. The cracks are formed so as to connect 50 to 500 first recesses 380a, for example.

The electrode foil 350 has a thickness F (μm). The first porous portion 360a has a thickness T (μm). The first recesses 380a have a depth H (μm). H/F and H/T are within the above-exemplified ranges, for example.

The opening shape of the first recesses illustrated in FIG. 2 is circular, but is not limited thereto. The opening shape of the recesses may be, for example, an oval shape, a rectangular shape, or a hexagonal shape. The shape of the first recesses is, but not limited to, cylindrical, and may be a pyramidal shape or a columnar shape other than the cylindrical shape. The first recesses have the same shape and size as each other, but the first recesses may have different shapes, different sizes, or both from each other. The arrangement of the first recesses is not limited to the arrangement illustrated in FIG. 2, and may be arranged in a square lattice shape, for example.

As illustrated in FIG. 3, the strip-shaped electrode foil 350 (metal foil) has a second porous portion 360b and a core portion 370 that is continuous with the second porous portion 360b. That is, the first porous portion 310a and the second porous portion 360b are arranged so as to sandwich the core portion 370. The electrode foil 350 has a second main surface S2 on which pores (not illustrated) of the second porous portion 360b open.

The porous portion 360b has a plurality of second recesses 380b that open on the second main surface S2. The second recesses 380b has the same shape, size, intervals, and arrangement as the first recesses 380a, but the first recesses and the second recesses may have shapes and the like different from each other.

### [Electrolytic Capacitor]

An electrolytic capacitor according to an embodiment of the present disclosure includes the electrode foil described above. The electrolytic capacitor includes a wound body and an electrolyte, for example. The wound body is constituted of an anode foil and a cathode foil wound with a separator between the anode foil and the cathode foil. A combination of the wound body and the electrolyte may be referred to as a capacitor element. At least one of the anode foil and the cathode foil includes the electrode foil described above.

There may be good-quality cracks between the recesses of the electrode foil in the wound body. The cracks are formed to connect the spaces between the recesses by winding the metal foil having the recess group.

In the direction (width direction) perpendicular to the winding direction of the metal foil, cracks preferably extend to connect at least two or more recesses. When the recess group is provided with a L/D of 2 or more and 50 or less, such cracks tend to be formed. For example, cracks are formed to connect 2 to 100 recesses.

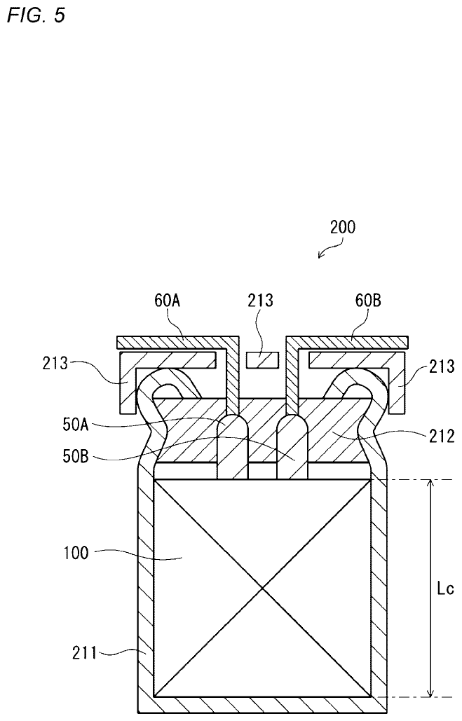

The wound body has a height Lc (Lc in FIG. 5) of, for example, 50 mm or less. Alternatively, the height Lc may be 20 mm or less, or 15 mm or less. The dimension of the height Lc of the wound body is substantially equal to the dimension in the width direction of the electrode foil or slightly longer than the dimension in the width direction of the electrode foil.

In the case of a large product (e.g., when the height Lc of the wound body is 30 mm or more), an electrode foil having a large width (e.g., 30 mm or less) is used. In the case of an electrode foil having a large width, foil tearing is likely to occur due to twisting of the electrode foil. Therefore, provision of the recess group in the electrode foil having a large width can significantly inhibit foil tearing caused by electrode foil twisting to increase reliability of a large product (e.g., a large capacitor of a screw terminal type or a lead terminal type).

In the case of a small product (e.g., when the height Lc of the wound body is 20 mm or less) by contrast, an electrode foil having a small width (e.g., 20 mm or less) is used. The electrode foil having a small width is obtained by slitting an electrode foil having a large width (e.g., 125 mm or more and 500 mm or less) into a desired small width (20 mm or less). Stress applied to the electrode foil during slitting is distributed in presence of the recess group to inhibit formation of cracks formed by the stress and inhibit foil tearing caused thereby. This significantly improves quality of the electrode foil with a small width. Further, in a capacitor production process, presence of the recess group significantly inhibits foil tearing due to generation of tension generated during transport of the electrode foil having a small width by the roller. As a result, aging (re-repair) during capacitor production is stably performed and characteristics such as leakage current of the capacitor can be stably obtained, thereby improving reliability of the small product.

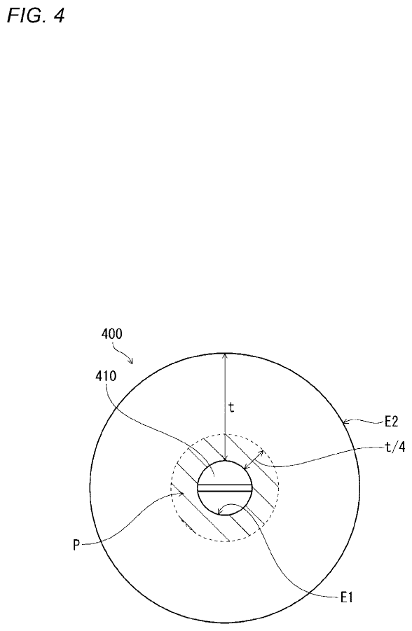

Here, FIG. 4 is a diagram schematically illustrating an example of the case where a wound body is viewed from a side of the end surface thereof. A wound body 400 is configured of an anode foil and a cathode foil wound around a core 410 with a separator therebetween. An “area P” refers to an area in which the radial distance from an innermost circumference E1 of the wound body 400 is (1/4)t or less, where t represents the radial thickness from the innermost circumference E1 to an outermost circumference E2 of the wound body 400.

Good-quality cracks can be present at least in the area P of the wound body. The cracks may be present more in the area P than in an area other than the area P. Foil tearing during electrode foil winding tends to occur in the area P where stress generated by winding tends to increase. Besides, good-quality cracks that relax the stress tend to be formed in the area P by electrode foil winding. As a result of the cracks being present in the area P, foil tearing during electrode foil winding can be effectively inhibited.

In the case where a stress generated by winding is large, the recess group may be provided on each of the main surfaces of the electrode foil. In the area P of the wound body, stress caused by winding is large. Therefore, the recess group is desirably provided on each of the main surfaces of the electrode foil.

### (Anode Foil)

As the anode foil, an electrode foil may be used that is obtained by the first step to the third step. The thickness of the anode foil may be 60 μm or more and 200 μm or less, for example, or may be 80 μm or more (or 100 μm or more) and 200 μm or less. An anode foil having a larger capacity tends to have a larger thickness. For example, in the case of a high-capacity anode foil having a thickness of 100 μm or more, effect of stress relaxation by crack formation between recesses is remarkably exhibited.

### (Cathode Foil)

As the cathode foil, an electrode foil may be used that is obtained by the first step and the second step. In the case of the cathode foil, a coating layer may be additionally formed on the surface of the metal foil (porous portion). Examples of the coating layer include a metal oxide layer, a metal nitride layer, a metal carbide layer, and a conductive layer (e.g., a layer containing at least one of metal and carbon). The thickness of the cathode foil is 10 μm or more and 70 μm or less, for example.

### (Separator)

The separator is not particularly limited. For example, a nonwoven fabric may be used that contains fibers of cellulose, polyethylene terephthalate, vinylon, or polyamide (e.g., an aliphatic polyamide or an aromatic polyamide such as aramid).

### (Electrolyte)

The electrolyte covers at least a part of the anode foil (dielectric layer), and is provided between the anode foil (dielectric layer) and the cathode foil. The electrolyte is a solid or liquid electrolyte. The electrolytic capacitor may include a liquid component (an electrolytic solution or a nonaqueous solvent) together with a solid electrolyte.

The solid electrolyte contains a conductive polymer. One Example of the conductive polymer is a π-conjugated polymer. Examples of the conductive polymer include polypyrrole, polythiophene, polyfuran, and polyaniline. One type of the conductive polymer may be used singly, or two or more types may be used in combination. Alternatively, a copolymer of two or more types of monomers may be used. The weight average molecular weight of the conductive polymer is 1000 to 100,000, for example.

In the present description, polypyrrole, polythiophene, polyfuran, and polyaniline, for example mean polymers respectively having polypyrrole, polythiophene, polyfuran, and polyaniline as a basic skeleton. Therefore, polypyrrole, polythiophene, polyfuran, polyaniline, and the like may also include their respective derivatives. For example, polythiophene include poly(3,4-ethylenedioxythiophene).

The conductive polymer may be doped with a dopant. The solid electrolyte may contain a dopant together with the conductive polymer. One example of the dopant is polystyrene sulfonic acid. The solid electrolyte may further contain an additive as necessary.

The liquid component is in direct contact with the dielectric layer or in contact therewith via the conductive polymer. The liquid component may be a nonaqueous solvent or an electrolytic solution. The electrolyte solution contains a nonaqueous solvent and an ionic substance (solute (e.g., organic salt)) dissolved therein. The nonaqueous solvent may be an organic solvent or an ionic liquid.

Preferably, the nonaqueous solvent is a high boiling-point solvent. Examples thereof that can be used include polyol compounds such as ethylene glycol, sulfonic compounds such as sulfolane, lactone compounds such as γ-butyrolactone, ester compounds such as methyl acetate, carbonate compounds such as propylene carbonate, ether compounds such as 1,4-dioxane, and ketone compounds such as methyl ethyl ketone.

The liquid component may include an acid component (anion) and a base component (cation). A salt (solute) may be formed of the acid component and the base component. The acid component contributes to a film repairing function. Examples of the acid component include organic carboxylic acids and inorganic acids. Examples of the inorganic acids include phosphoric acid, boric acid, and sulfuric acid. Examples of the base component include primary to tertiary amine compounds.

The organic salt refers to a salt in which at least one of an anion and a cation contains an organic substance. Examples of the organic salt that can be used include trimethylamine maleate, triethylamine borodisalicylate, ethyldimethylamine phthalate, mono1,2,3,4-tetramethylimidazolinium phthalate, and mono1,3-dimethyl-2-ethylimidazolinium phthalate.

In view of inhibiting dopant dedoping from the conductive polymer (degradation of the solid electrolyte), the liquid component preferably contains a larger amount of the acid component than the base component. In addition, since the acid component contributes to the film repairing function of the liquid component, the liquid component preferably contains a larger amount of the acid component than the base component. The molar ratio of the acid component to the base component (acid component/base component) is 1.1 or more, for example. In view of, for example, inhibiting dopant dedoping from the conductive polymer, the pH of the liquid component may be 6 or less, or may be 1 or more and 5 or less.

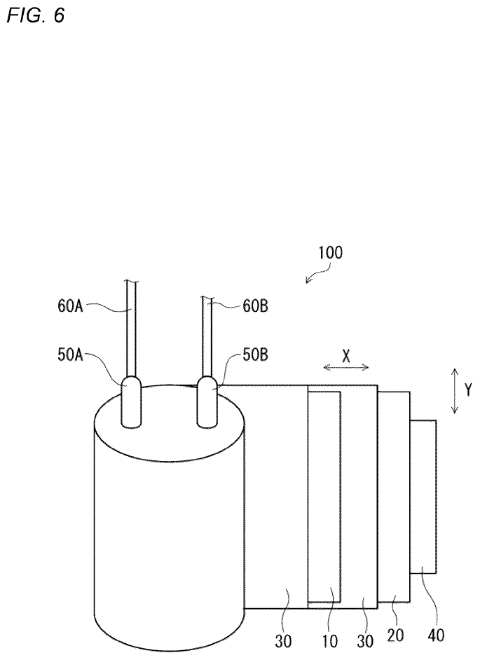

Here, FIG. 5 is a schematic cross-sectional view of an electrolytic capacitor according to an embodiment of the present disclosure. FIG. 6 is a schematic perspective view of the configuration of a wound body. In FIG. 6, the X direction indicates the length direction of a strip-shaped anode foil 10 and a cathode foil 20, and the Y direction indicates the width direction of the anode foil 10 and the cathode foil 20.

An electrolytic capacitor 200 includes a capacitor element, and the capacitor element includes a wound body 100 and an electrolyte (not illustrated). The wound body 100 is configured of the anode foil 10 and the cathode foil 20 wound with separators 30 therebetween. The wound body 100 has a height Lc that is substantially the same as the dimensions of the anode foil 10 and the cathode foil 20 in the widthwise direction (Y direction).

One ends of lead tabs 50A and 50B are connected to the anode foil 10 and the cathode foil 20, respectively, and the wound body 100 is constituted of the lead tabs 50A and 50B that are wound together. Lead wires 60A and 60B are connected to the other ends of the lead tabs 50A and 50B, respectively.

Winding tape 40 is disposed on the outer surface of the cathode foil 20 located as the outermost layer of the wound body 100, and the end of the cathode foil 20 is fixed by the winding tape 40. In the case where the anode foil 10 is prepared by cutting a large-sized foil, chemical conversion treatment may be further performed on the wound body 100 in order to provide a dielectric layer on the cut section.

The electrolyte is provided between the anode foil 10 (the dielectric layer) and the cathode foil 20 of the wound body 100. The capacitor element is obtained, for example, by impregnating the wound body 100 with a treatment liquid containing the electrolyte. Impregnation may be carried out in a reduced pressure atmosphere, for example, in a 10 kPa to 100 kPa atmosphere.

The wound body 100 is housed in a bottomed case 211 so that the lead wires 60A and 60B are positioned near the opening of the bottomed case 211. As a material of the bottomed case 211, a metal such as aluminum, stainless steel, copper, iron, brass, or an alloy thereof can be used.

The wound body 100 is sealed in the bottomed case 211 in a manner that a sealing member 212 is placed in the opening of the bottomed case 211 in which the wound body 100 is housed, the opening end of the bottomed case 211 is curled to the sealing member 212 by crimping, and a seat plate 213 is placed on the curled part.

The sealing member 212 is formed so as to allow the lead wires 60A, 60B to pass therethrough. The sealing member 212 should be made of an insulating material, and is preferably an elastic body. Above all, silicone rubber, fluoro rubber, ethylene propylene rubber, hyperon rubber, butyl rubber, or isoprene rubber, each of which as high heat resistance, is preferable, for example.

### <Supplementary Remarks>

According to the above description of the embodiments, the following techniques are disclosed.

### (Technique 1)

A metal foil used for producing an electrode foil for electrolytic capacitor use, including a metal foil containing a valve metal, wherein
the metal foil has a plurality of recesses that open on a main surface of the metal foil and that are arranged to be distributed in a dot-like manner in a direction of the main surface, and
an opening diameter of the recesses is 2 μm or more.

### (Technique 2)

The metal foil used for producing an electrode foil according to Techniques 1, wherein the opening diameter of the recesses is 5 μm or more and 50 μm or less.

### (Technique 3)

The metal foil used for producing an electrode foil according to Techniques 1 or 2, wherein mutually adjacent recesses of the recesses are spaced apart by an interval L of 4 m or more.

### (Technique 4)

The metal foil used for producing an electrode foil according to any one of Techniques 1 to 3, wherein the metal foil contains 98 mass % or more of aluminum as the valve metal.

### (Technique 5)

The metal foil used for producing an electrode foil according to Technique 4, containing
1 mass ppm or more and 100 mass ppm or less of silicon;
5 mass ppm or more and 100 mass ppm or less of copper; and
5 mass ppm or more and 200 mass ppm or less of iron.

### (Technique 6)

The metal foil used for producing an electrode foil according to any one of Techniques 1 to 5, wherein the metal foil has a tensile strength of 40 N/mm² or more.

### (Technique 7)

The metal foil used for producing an electrode foil according to any one of Techniques 1 to 6, wherein the metal foil has an elongation rate of 1% or more and 16% or less.

### (Technique 8)

The metal foil used for producing an electrode foil according to any one of Techniques 1 to 7, wherein a thickness F (μm) of the metal foil and a depth H (μm) of the recesses have a relationship of 0.26≤H/F≤0.47.

### (Technique 9)

The metal foil used for producing an electrode foil according to any one of Techniques 1 to 8, wherein a depth H of the recesses is 4 μm or more and 74 μm or less.

### (Technique 10)

The metal foil used for producing an electrode foil according to any one of Techniques 1 to 9, wherein a thickness F of the metal foil is 80 μm or more and 200 μm or less.

### (Technique 11)

The metal foil used for producing an electrode foil according to any one of techniques 1 to 10, wherein the metal foil has 7 or more and 570 or less recesses of the recesses per area of 1 mm² of the main surface.

### (Technique 12)

The metal foil used for producing an electrode foil according to any one of Techniques 1 to 11, wherein
respective mutually adjacent recesses of the recesses have opening diameters of D₁ (μm) and D₂ (μm), and are spaced apart from each other by an interval L (μm),
the opening diameter D₁ and the interval L satisfy relationships of 2≤D₁ and 2≤L/D₁≤50, and
the opening diameter D₂ and the interval L satisfy relationships of 2≤D₂ and 2≤L/D₂≤50.

### (Technique 13)

The metal foil used for producing an electrode foil according to any one of Techniques 1 to 12, wherein 2 or more crystal grains of the metal foil are exposed on inner wall surfaces of the recesses in a depth direction of the recesses.

### (Technique 14)

The metal foil used for producing an electrode foil according to any one of Techniques 1 to 13, wherein an average crystal grain diameter of the metal foil is 18 μm or more and 60 μm or less.

### (Technique 15)

A method for producing an electrode foil for electrolytic capacitor use, including
preparing the metal foil used for producing the electrode foil according to any one of claims 1 to 14; and
etching the metal foil.

### (Technique 16)

The method for producing an electrode foil for electrolytic capacitor use according to Technique 15,
in the etching, a porous portion is formed on the main surface of the metal foil and inner wall surfaces of the recesses,
the porous portion has pores that open on the main surface of the metal foil and the inner wall surfaces of the recesses, and
an opening diameter of the pores of the porous portion is less than 2 km.

### (Technique 17)

The method for producing an electrode foil for electrolytic capacitor use according to Technique 16, wherein
a thickness T (μm) of the porous portion and a depth H (μm) of the recesses have a relationship of 0.2≤H/T≤1.1.

### (Technique 18)

The method for producing an electrode foil for electrolytic capacitor use according to Technique 16, further including
forming a dielectric layer covering a metal skeleton constituting the porous portion.

### (Technique 19)

An electrode foil for electrolytic capacitor use obtained by the method for producing an electrode foil for electrolytic capacitor use according to any one of Techniques 15 to 18.

### (Technique 20)

An electrode foil for electrolytic capacitor use including a valved metal, wherein
the metal foil has a plurality of recesses that open on a main surface of the metal foil and that are arranged to be distributed in a dot-like manner in a direction of the main surface,
the metal foil has a porous portion having pores that open on the main surface of the metal foil and inner wall surfaces of the recesses,
an opening diameter of the recesses is 2 μm or more, and
an opening diameter of the pores of the porous portion is less than 2 μm.

### (Technique 21)

The electrode foil for electrolytic capacitor use according to Technique 20, further including a dielectric layer covering a metal skeleton constituting the porous portion.

### (Technique 22)

An electrolytic capacitor comprising the electrode foil for electrolytic capacitor use according to any one of Techniques 19 to 21.

### EXAMPLES

Hereinafter, the present disclosure will be described in detail based on examples and comparative examples, but the present disclosure is not limited to the examples.

### Examples 1 to 15

### (First Step: Raw Material Foil Preparation)

First, strip-shaped Al foils (plain foils, thickness F: 120 μm, average crystal grain diameter: 40 μm) were prepared. Each of the Al foils used was a rolled foil in which the rolling direction was parallel to the length direction (X direction). In the Al foil: the Al content rate was 99.98 mass %; the silicon content was 40 mass ppm, the iron content was 40 mass ppm, and the copper content was 30 mass ppm.

A plurality of cylindrical recesses were formed on both sides of the Al foil using a specific jig to form a group of recesses arranged in a staggered manner as illustrated in FIG. 2. The depth H of the recesses was appropriately adjusted to set the ratio H/F as indicated in Table 1. For example, in an electrode foil a1, the depth H of the recesses was set to 45 μm. Raw material foils were obtained in the manner described above.

The tensile strength of each raw material foil determined by the above-described method was 65 N/mm². The elongation rate of the raw material foil determined by the above-described method was 10%. The number of crystal grains of the Al foil exposed on the inner wall surfaces of the recesses of the recesses in the depth direction was 3.

The opening diameter D and the interval L (L₁=L₃) of the recesses in FIG. 2 were set as indicated in Table 1. The number of recesses present per area of 1 mm² of the main surface of each raw material foil was as indicated in Table 1.

### (Second Step: Etching (Porous Portion Formation))

The raw material foil was etched. As a result, a porous portion (thickness T: 45 μm, average pore diameter Dp: 0.2 μm) having sponge-shaped pits was formed on both main surfaces of the raw material foil. The depth H of the recesses was appropriately adjusted to set the H/T as indicated in Table 1. Etched foils were obtained in the manner described above.

### (Third Step: Chemical Conversion Treatment)

Further, each etched foil was subjected to chemical conversion treatment to form a dielectric layer having a withstand voltage corresponding to 60 V on the surface of a metal part constituting the porous portion, thereby obtaining chemically converted foils. Electrode foils a1 to a15 were obtained in the manner described above.

### Comparative Example 1

An electrode foil b1 was prepared in the same manner as in Example 1, except that the recess group was not formed in an Al foil.

Evaluation 1 described below was carried out on the electrode foils (chemically converted foils) of Examples and Comparative Example obtained above.

### [Evaluation 1: Folding Endurance Measurement]

The folding endurance in the width direction (Y direction) of each of the electrode foils was measured. Measurement was done in accordance with the test methods of the electrode foil for aluminum electrolytic capacitors (EIAJ RC-2364A) defined in Standard of Electronic Industries Association of Japan. The measurement was done using a test piece obtained by cutting the electrode foil into dimensions of 100 mm in the length direction and 10 mm in the width direction.

### [Evaluation 2: Capacity Measurement]

The capacity of each of the electrode foils was measured in accordance with the test methods of the electrode foil for aluminum electrolytic capacitors (EIAJ RC-2364A) defined in Standard of Electronic Industries Association of Japan.

The folding endurance and the capacity were expressed as relative values on the assumption that each of the folding endurance and the capacity of the electrode foil b1 of Comparative Example 1 was 100. Evaluation results are shown in Table 1.

TABLE 1

| | Raw material foil | | | | | | | |
|---|---|---|---|---|---|---|---|---|
| | | | | Number of | | | | |
| | | | | recesses | | | | |
| | Recess | | | per 1 mm² | | | Folding | |
| | opening | Recess | | of main | | Etched | endurance | Capacity |
| Electrode | diameter | interval | | surface | | foil | (relative | (relative |
| foil | D (μm) | L (μm) | L/D | (count) | H/F | H/T | value) | value) |
| — | — | — | — | — | — | — | 100 | 100 |
| a1 | 20 | 220 | 11 | 17 | 0.38 | 1.0 | 118 | 101 |
| a2 | 20 | 160 | 8 | 31 | 0.38 | 1.0 | 112 | 103 |
| a3 | 20 | 100 | 5 | 69 | 0.38 | 1.0 | 120 | 102 |
| a4 | 30 | 210 | 7 | 17 | 0.38 | 1.0 | 107 | 102 |
| a5 | 30 | 150 | 5 | 31 | 0.38 | 1.0 | 107 | 102 |
| a6 | 30 | 90 | 3 | 69 | 0.38 | 1.0 | 123 | 104 |
| a7 | 40 | 320 | 8 | 8 | 0.38 | 1.0 | 107 | 102 |
| a8 | 20 | 160 | 8 | 31 | 0.38 | 1.0 | 113 | 102 |
| a9 | 20 | 160 | 8 | 31 | 0.27 | 0.70 | 114 | 104 |
| a10 | 20 | 160 | 8 | 31 | 0.13 | 0.35 | 117 | 103 |
| a11 | 30 | 150 | 3 | 31 | 0.38 | 1.0 | 110 | 102 |
| a12 | 30 | 150 | 3 | 31 | 0.27 | 0.70 | 115 | 102 |
| a13 | 30 | 150 | 3 | 31 | 0.13 | 0.35 | 123 | 104 |
| a14 | 20 | 160 | 8 | 31 | 0.05 | 0.13 | 117 | 103 |
| a15 | 30 | 150 | 3 | 31 | 0.52 | 1.35 | 107 | 102 |

The electrode foils a1 to a15 each had a higher folding endurance than the electrode foil b1.

### Comparative Example 2

### (Etched Foil Production)

An Al foil was etched to form a porous portion (thickness T: 45 μm, average pore diameter Dp: 0.2 m) having sponge-shaped pits on each of the main surfaces of the Al foil. In the manner described above, an etched foil was obtained. The same Al foil as those used in the first embodiment was used.

### (Recess Group Formation in Etched Foils)

Recess groups were provided on the respective main surfaces of the etched foil using a specific jig. The recess groups were formed in the same manner as that in Example 1.

An electrode foil b2 was produced and evaluated in the same manners as those for the electrode a1 of Example 1 except for the above. Evaluation results of the electrode foil b2 are shown in Table 2 together with those of the electrode foils a1 and b1. The folding endurance and the capacity were expressed as relative values on the assumption that the folding endurance and the capacity of the electrode foil b1 of Comparative Example 1 each were 100.

TABLE 2

| | | Folding | |
|---|---|---|---|
| Elec- | | endurance | Capacity |
| trode | | (relative | (relative |
| foil | Process of electrode foil production | value) | value) |
| b1 | Etching without recess group formation | 100 | 100 |
| b2 | Etching following recess group formation | 115 | 99 |
| a1 | Etching after recess group formation | 118 | 101 |

The folding endurance of the electrode foil b2 was larger than that of the electrode foil b1, but the capacity was lower.

When the metal foil is etched and a recess group is then provided on the etched foil, the etched pits located in the vicinity of the inner wall surfaces of the recesses are clogged when forming the recess group, so that etched pits that open on the inner wall surfaces of the recesses are less likely to form. This results in a smaller surface area of the metal foil to reduce the capacity. Further, in this case, etched pits in the vicinity of the inner wall surfaces of the recesses are clogged when forming the recesses, with a result that a dispersion (or an electrolyte solution) of the conductive polymer does not reach the deep parts of the etched pits, and the parts may not contribute to the capacity.

By contrast, the electrode foil a1 had a higher folding endurance and a higher capacity than the electrode foil b1.

When the metal foil (raw material foil) having the recess group is etched, etched pits that open on the inner wall surfaces of the recesses and also on the main surfaces of the metal foil are formed. This increases the surface area of the metal foil to increase the capacity. Decreases in strength and capacity can be avoided that is caused by deformation (melting) of the porous portion during recess group formation. In this case, since etched pits in the vicinity of the inner wall surfaces are not clogged, the dispersion (or the electrolyte solution) of the conductive polymer reaches the deep parts of the etched pits, with a result that the deep parts of the etched pits can also contribute to the capacity. In a hybrid electrolytic capacitor in which a solid-state electrolyte and an electrolytic solution are used in combination, even a small amount of the electrolytic solution can efficiently reach the deep parts of the pits, and thus effects of ESR reduction by the electrolytic solution can be easily obtained.

### INDUSTRIAL APPLICABILITY

The electrode foil according to the present disclosure is preferably used for electrolytic capacitors that require high reliability.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE NUMERALS

1: recess, 2: porous portion, 10: anode foil, 20: cathode foil, 30: separator, 40: winding tape, 50A and 50B: lead tab, 60A and 60B: lead wire, 100 and 400: wound body, 200: electrolytic capacitor, 211: bottomed case, 212: sealing member, 213: seat plate, 350 and 351: electrode foil, 360a: first porous portion, 360b: second porous portion, 361: porous portion, 370: core portion, 380a: first recess, 380b: second recess, 381 and 382: recess, 410: core

What is claimed is:

1. A metal foil used for producing an electrode foil for electrolytic capacitor use, comprising
a valve metal, wherein
the metal foil has a plurality of recesses that open on a main surface of the metal foil and that are arranged to be distributed in a dot-like manner in a direction of the main surface, and
an opening diameter of the recesses is 2 μm or more.

2. The metal foil used for producing the electrode foil according to claim 1, wherein
the opening diameter of the recesses is 5 μm or more and 50 μm or less.

3. The metal foil used for producing the electrode foil according to claim 1, wherein
mutually adjacent recesses of the recesses are spaced apart by an interval L of 4 μm or more.

4. The metal foil used for producing the electrode foil according to claim 1, wherein
the metal foil contains 98 mass % or more of aluminum as the valve metal.

5. The metal foil used for producing the electrode foil according to claim 4, comprising:
1 mass ppm or more and 100 mass ppm or less of silicon;
5 mass ppm or more and 100 mass ppm or less of copper; and
5 mass ppm or more and 200 mass ppm or less of iron.

6. The metal foil used for producing the electrode foil according to claim 1, wherein
the metal foil has a tensile strength of 40 N/mm² or more.

7. The metal foil used for producing the electrode foil according to claim 1, wherein
the metal foil has an elongation rate of 1% or more and 16% or less.

8. The metal foil used for producing the electrode foil according to claim 1, wherein
a thickness F (μm) of the metal foil and a depth H (μm) of the recesses have a relationship of 0.26≤H/F≤0.47.

9. The metal foil used for producing the electrode foil according to claim 1, wherein
a depth H of the recesses is 4 μm or more and 74 μm or less.

10. The metal foil used for producing the electrode foil according to claim 1, wherein
a thickness F of the metal foil is 80 μm or more and 200 μm or less.

11. The metal foil used for producing the electrode foil according to claim 1, wherein
the metal foil has 7 or more and 570 or less recesses of the recesses per area of 1 mm² of the main surface.

12. The metal foil used for producing the electrode foil according to claim 1, wherein
respective mutually adjacent recesses of the recesses have opening diameters of D₁ (μm) and D₂ (μm), and are spaced apart from each other by an interval L (μm),
the opening diameter D₁ and the interval L satisfy relationships of 2≤D₁ and 2≤L/D₁≤50, and
the opening diameter D₂ and the interval L satisfy relationships of 2≤D₂ and 2≤L/D₂≤50.

13. The metal foil used for producing the electrode foil according to claim 1, wherein
2 or more crystal grains of the metal foil are exposed on inner wall surfaces of the recesses in a depth direction of the recesses.

14. The metal foil used for producing the electrode foil according to claim 1, wherein
an average crystal grain diameter of the metal foil is 18 μm or more and 60 μm or less.

15. A method for producing an electrode foil for electrolytic capacitor use, comprising:
preparing the metal foil used for producing the electrode foil according to claim 1; and
etching the metal foil.

16. The method for producing an electrode foil for electrolytic capacitor use according to claim 15, wherein
in the etching, a porous portion is formed on the main surface of the metal foil and inner wall surfaces of the recesses,
the porous portion has pores that open on the main surface of the metal foil and the inner wall surfaces of the recesses, and
an opening diameter of the pores of the porous portion is less than 2 μm.

17. The method for producing an electrode foil for electrolytic capacitor use according to claim 16, wherein
a thickness T (μm) of the porous portion and a depth H (μm) of the recesses have a relationship of 0.2≤H/T≤1.1.

18. The method for producing an electrode foil for electrolytic capacitor use according to claim 16, further comprising
forming a dielectric layer covering a metal skeleton constituting the porous portion.

19. An electrode foil for electrolytic capacitor use obtained by the method for producing an electrode foil for electrolytic capacitor use according to claim 15.

20. An electrode foil for electrolytic capacitor use comprising
a metal foil containing a valve metal, wherein
the metal foil has a plurality of recesses that open on a main surface of the metal foil and that are arranged to be distributed in a dot-like manner in a direction of the main surface,
the metal foil has a porous portion having pores that open on the main surface of the metal foil and inner wall surfaces of the recesses,
an opening diameter of the recesses is 2 μm or more, and
an opening diameter of the pores of the porous portion is less than 2 μm.

21. The electrode foil for electrolytic capacitor use according to claim 20, further comprising
a dielectric layer covering a metal skeleton constituting the porous portion.

22. An electrolytic capacitor comprising the electrode foil for electrolytic capacitor use according to claim 19.
